(19) United States
(12) Patent Application Publication
(10) Pub. No.: US 2024/0239544 A1
(43) Pub. Date: Jul. 18, 2024

(54) METHOD FOR OPERATING A LABELLING SYSTEM

(71) Applicant: Espera-Werke GmbH, Duisburg (DE)

(72) Inventors: Nadina KORTHÄUER, Mülheim an der Ruhr (DE); Thorsten ZERFAß, Mülheim an der Ruhr (DE)

(21) Appl. No.: 18/559,509

(22) PCT Filed: May 11, 2022
(86) PCT No.: PCT/EP2022/062810

§ 371 Date: Nov. 7, 2023

(30) Foreign Application Priority Data
May 12, 2021 (DE) 10 2021 112 479.4

(51) Int. Cl. B65C 9/40; B65C 9/02; B65C 9/18; B65C 9/46

(52) U.S. Cl. CPC B65C 9/40; B65C 9/02; B65C 9/18; B65C 9/46

(57) ABSTRACT

The invention relates to a method for operating a labelling system (1) comprising at least one labelling apparatus (2) for labelling, in particular for price labelling, individual packages (3), the labelling apparatus (1) comprising, as functional units, at least one feed assembly (4), a label-dispensing assembly (5), a label-application assembly (6), and a printer assembly (7), which are controlled by a control assembly (8) of the labelling system (1) in a labelling routine, the labelling apparatus (1) comprising a sensor assembly (16), preferably a camera, by means of which images (17) of each of the packages (3) are recorded, the images (17) of each of the packages (3) being analysed in an analysis routine by means of the control assembly (8), a classification of each package (3) into a package class being derived by means of this analysis, and the labelling apparatus (2) being controlled in the labelling routine depending on said classification. According to the invention, the analysis routine is based on an application of a trained machine learning model to the images (17), said application being carried out by means of the control assembly (8).

The invention relates to a method for operating a labeling system according to the preamble of claim 1, to a labeling system having at least one labeling apparatus according to the preamble of claim 15, and to a data medium having a training data set for use in such a method as claimed in claim 16.

The labeling systems in question here for the labeling of individual packages have at least one labeling apparatus, which in particular is configured as a price labeling apparatus. The labeling apparatus is equipped at least with a feed arrangement, a label dispensing arrangement and a label affixing arrangement as functional units, which are adapted for labeling the individual packages in a labeling routine. The functional units are driven in the labeling routine by means of a control arrangement.

The feed arrangement is in particular a belt conveyor or a roller conveyor for moving the respective packages, it being possible to carry out labeling of the moved packages in ongoing operation. In principle, it is known to carry out the labeling routine with a chaotic package delivery, different types of packages being delivered to the feed arrangement in an arbitrary sequence. In this case, the chaotic package delivery generally requires at least partially automatic recognition of the respective package with a classification, in order to allow labeling that relates to a respective package class.

The automatic recognition of the packages may, for example, be carried out with the aid of weight values of the respective packages, each package class being assigned a weight range. For the categorization into the package classes, sensor arrangements such as cameras are furthermore used, the respective package class being deduced with the aid of the recorded images of the packages, for instance with the aid of the package geometry.

One challenge is that misrecognitions of the packages may occur with the chaotic package delivery. For example, in the case of recognition according to the weight values, it may therefore be necessary that the weight values of packages of different package classes do not overlap. In principle, in the case of camera-assisted classification it is also desirable to deliver packages of different package classes with a very similar appearance, without misrecognitions occurring.

The object of the invention is to provide a method for operating a labeling system for the labeling of individual packages, particularly flexible package delivery being made possible.

The above object is achieved in the case of a method according to the preamble of claim 1 by the features of the characterizing part of claim 1.

It is assumed that images of the respective packages are analyzed by means of the control arrangement in an analysis routine, a classification of the respective package into a package class being derived by means of this analysis and the driving of the labeling apparatus in the labeling routine being carried out as a function of the classification.

What is essential is the basic idea that, in the case of chaotic package delivery of various packages with a similar appearance, conventional methods of image processing rapidly reach their limits. At the same time, rapid image recognition is necessary in order to allow the classification in ongoing operation.

In detail, it is proposed for the analysis routine to be based on an application of a trained machine learning model to the images, which is carried out by means of the control arrangement.

The use of a machine learning method can significantly improve the classification of the respective packages in the case of chaotic package delivery. Although a classification of arbitrary image information items on the basis of a machine learning model may generally be computation-intensive, in the present case it has however been found that recording of the images in a substantially controlled environment is possible with the labeling, which significantly reduces the requirements for computation power in the analysis routine even when applying a machine learning model, and furthermore allows targeted training of the machine learning model. The application of a machine learning model may in this case even allow classification with high accuracy in real time, so that high process speeds are achievable even with chaotic product delivery.

The preferred configurations according to claims 2 and 3 relate to printing of the labels as a function of the classification derived in the analysis routine. Weight-dependent price labeling of the respective packages on the basis of a basic price assigned to the package class is particularly preferred in this case.

In the preferred configurations according to claims 4 and 5, the flexibility in respect of the diversity of the packages delivered is furthermore used so that a plurality of label types are available, which are affixed as a function of the package class for the respective package. The type of affixing and the speed of the transport of the packages may also be varied according to the package class. The classification also allows sorting of the packages as a function of their respective package class (claim 6).

In the preferred configuration according to claim 7, the trained machine learning model is based on a trained neural network, for instance a convolutional neural network. Convolutional neural networks achieve particularly good results in image processing.

According to claim 8, a feature extractor may be used for the classification, the classification being carried out with the aid of the feature space that is generated. It is particularly advantageous in this case for at least one of the steps, and preferably both steps, to be implemented by applying the trained machine learning model.

According to claim 9, a proposal step with which proposed regions in the image are identified, which are in turn employed in the classification step, is furthermore provided in the analysis routine. Particularly in the case of packages in which individual products are at least partially visible, for instance packages with a transparent covering, this configuration may lead to a simplification of the analysis routine.

Claims 10 and 11 relate to a learning routine on the basis of a training data set. Particularly useful in this case is the configuration according to claim 11, according to which the training data set is derived at least partially from images in a previous and/or ongoing labeling routine. For example, a labeling routine without chaotic package delivery may be used to construct a large and dependable training data set. If respective packages of the same package class are labeled therein at least during certain periods of time, the annotation of the images for the training data set may be simplified significantly.

Also particularly advantageous is the use of an aligning arrangement according to claim 12, for example having a guide element for the respective packages, so that the packages can appear at a well-defined and reproducible position in the recorded images. In this way, a higher reliability of the classification and a further improvement of the training data set are achieved.

Likewise, according to claim 13, a predefined distance between the sensor arrangement and the respective packages may be provided, so that for example the outlay associated with scaling of the images in the analysis routine is reduced.

The configuration according to claim 14 furthermore envisions that a plurality of labeling apparatuses may also be driven via the control arrangement. The control arrangement may in this case implement central management of the package classes and/or central performance of the analysis routine, for example on the basis of a cloud.

By a further teaching according to claim 15, to which independent importance is attributed, a labeling system having at least one labeling apparatus for the labeling of individual packages is claimed per se. The labeling system is, in particular, adapted to carry out the proposed method. Reference is made to all remarks concerning the proposed method.

By a further teaching according to claim 16, to which independent importance is likewise attributed, a data medium having a training data set for use in the proposed method is claimed. Reference is made to all remarks concerning the proposed method.

The invention will be explained in more detail below with the aid of a drawing, which merely represents an exemplary embodiment. In the drawing,

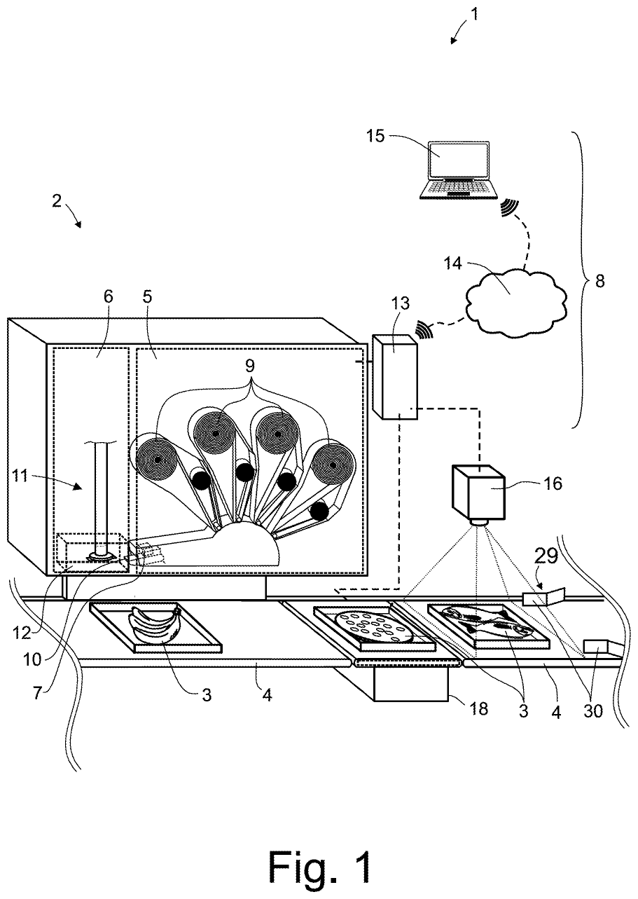

FIG. 1 shows a schematic representation of the proposed labeling system for carrying out the proposed method,

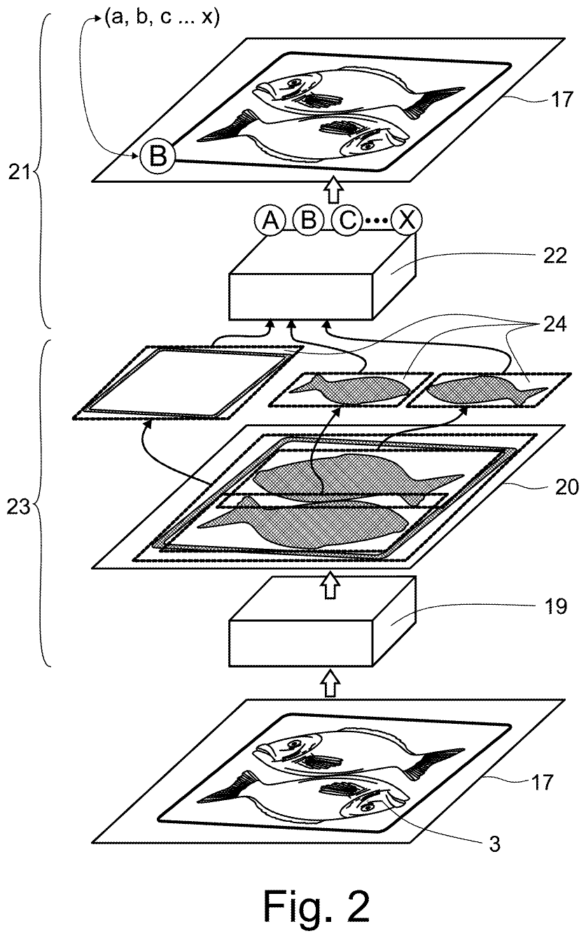

FIG. 2 shows a schematic representation of the analysis routine used in the proposed method based on the trained machine learning model, and

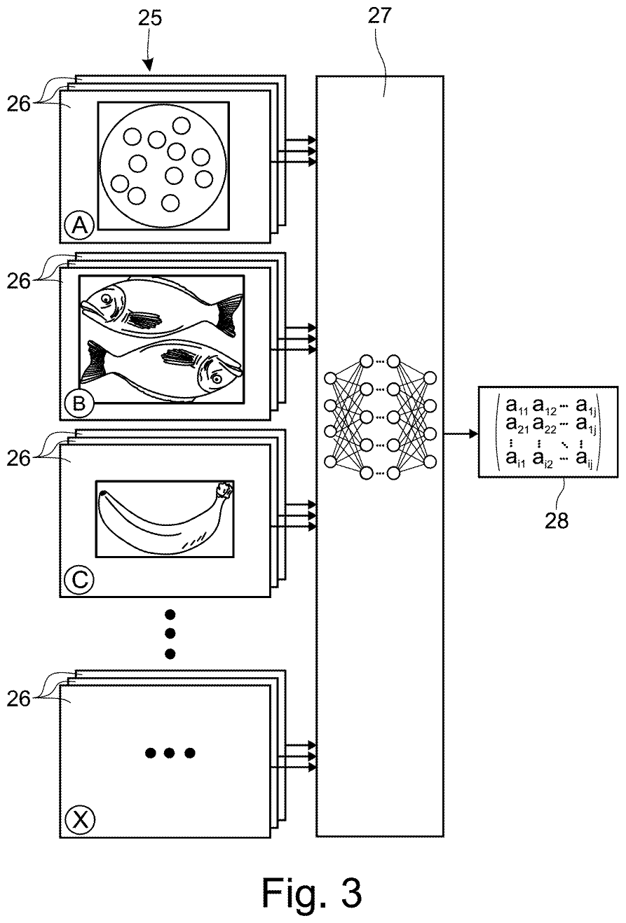

FIG. 3 shows a schematic representation of the learning routine for the proposed method.

The invention relates to a method for operating a labeling system 1 having at least one labeling apparatus 2 for the labeling of individual packages 3. FIG. 1 shows a schematic representation of the labeling apparatus 2 in a preferred configuration as a price labeling apparatus.

The labeling apparatus 2 has at least a feed arrangement 4, a label dispensing arrangement 5, a label affixing arrangement 6 and a printer arrangement 7 as functional units, which are adapted to carry out a labeling routine for the packages 3. Besides the aforementioned functional units, further functional units of the labeling apparatus 2 may also be provided. The functional units are driven by a control arrangement 8 of the labeling system 1 in a labeling routine, which involves labeling the individual packages 3.

In the labeling routine, respective packages 3 are transported by means of the feed arrangement 4, labels which are detachable from a material strip 9 are dispensed by means of the label dispensing arrangement 5, the dispensed label is affixed onto the respective package 3 by means of the label affixing arrangement 6 and the label detachable or detached from the material strip 9 is printed by means of the printer arrangement 7.

The feed arrangement 4 is configured for the transport of respective packages. The feed arrangement 4 is preferably a belt conveyor or a roller conveyor, and optionally at least one robot arm, for moving the respective packages 3. The feed arrangement 4, here the belt conveyor, here and preferably has at least one conveyor belt, via which the respective packages 3 are transported along a transport direction.

Furthermore, the label dispensing arrangement 5 is adapted to dispense the label. Preferably, the label is detached from a material strip 9 by means of the label dispensing arrangement 5. A label which is detachable from a material strip 9 means in particular a label which is affixed detachably with its adhesive face on a carrier strip, which forms the material strip 9 and may for example consist of paper and/or plastic. It is likewise possible for the label to be produced by separation of a subsection from a printable or printed material strip 9, for instance by cutting and/or tearing the material strip 9. Here, and according to a preferred configuration, labels configured as adhesive labels, which already have an adhesive face on the material strip 9, are used. The material strip 9 is in this case guided over a dispensing edge 10 so that the labels are detached. It is likewise also possible to envision the use of adhesive-free labels, which are only subsequently provided with an adhesive face or are affixed onto an adhesive face on the respective package 3.

The labeling apparatus 2, here in a common housing with the label dispensing arrangement 5, also has the label affixing arrangement 6 for affixing the dispensed label onto the respective package 3. As is schematically represented in FIG. 1, here and preferably the label affixing arrangement 6 has a stamp 11 for affixing a label onto the upper side of the package 3. The stamp 11 transfers the label onto the surface of the package 3 in an affixing movement.

Here and preferably, the stamp 11 is configured as a swinging stamp, which is both linearly displaceable and tiltable. In particular, as its stamp foot the stamp 11 has a suction foot, preferably a suction and blowing foot, for suctioning and in particular also ejecting the label. The stamp 11, configured here as a swinging stamp, in this case performs an affixing movement along the transport direction during the transfer of the label, in order to allow labeling of the package 3 moved by means of the feed arrangement 4. It is preferred in this case for the stamp 11 also to be displaceable in a direction orthogonal to the transport direction, in order to allow affixing of the labels at different positions of the packages 3 orthogonally to the transport direction.

With the label affixing arrangement 6, the label can be affixed by contact, that is to say mechanically, by pressing the label onto the package 3. Additionally or alternatively, it is conceivable for the label to be affixed contactlessly, for example by a suction and blowing foot of the stamp 11 ejecting, that is to say pneumatically affixing, the label onto the package 3 by generating a compressed-air impulse directed toward the package 3. In principle, the stamp 11 may however also be a simple linear stamp, which is then movable only linearly, optionally in a plurality of mutually orthogonal directions.

As is schematically represented in FIG. 1, in this case a label suction arrangement 12 which transfers the detached labels to the stamp 11 is provided. According to another embodiment, not represented here, it is in principle also conceivable for the label to be transferred directly onto the surface of the package 3, in particular by means of a compressed-air impulse exerted onto the label by the label suction arrangement 12, preferably by a blowing head. In this case, a stamp 11 is then not required for the transfer of the label.

The printer arrangement 7 for printing the label is furthermore provided, printing of the label being performable in principle on the material strip 9 after detachment of the label from the material strip 9 as well as before and/or after the affixing of the label onto the respective package 3. Here and preferably, a printer arrangement 7 adapted for thermal printing is provided. The printer arrangement 7 may likewise have a laser printer and/or inkjet printer. The printer arrangement 7 is preferably integrated into the label dispensing arrangement 5, as is represented, and prints the labels before, after and/or during the dispensing.

The control arrangement 8 oversees the control-technology tasks occurring in the labeling routine. Preferably, the control arrangement 8 has at least one computer device, which is adapted to drive the functional units. FIG. 1 shows by way of example a local control unit 13 of the labeling apparatus 2, which communicates with a cloud-based server 14 via a wired and/or wireless network, for example a local network, a mobile communications network and/or the Internet. A mobile device 15, which likewise communicates with the further components of the control arrangement 8 via the network, is furthermore provided. Other variants of the control arrangement 8 are conceivable. For example, alternatively to the control arrangement 8 represented, having a plurality of components, merely a local control arrangement 8 may also be provided on the labeling apparatus 2.

The labeling apparatus 2 furthermore has a sensor arrangement 16, which is preferably configured as an optical sensor arrangement and, here and preferably, as a camera. By means of the sensor arrangement 16, images 17 of the respective packages 3 are recorded. Accordingly, the images 17 are preferably camera images, in particular two-dimensional or three-dimensional image information items of the respective package 3. The camera may be configured as a color camera, and in particular as a 3D camera. Further configurations of the sensor arrangement 16 are conceivable, for example with IR sensors or the like. The sensor arrangement 16 is here and preferably arranged on the feed arrangement 4, so that images 17 of the respective package 3 on the feed arrangement 4 are recorded, preferably in the case of a moved package 3. Further configurations of the sensor arrangement 16 which can record images 17 representative of the appearance of the packages 3, for example by means of laser scanning or the like, are also conceivable.

As mentioned in the introduction, with the proposed method the focus is on a chaotic package delivery, packages 3 with different requirements being processed in the labeling routine. By means of the control arrangement 8, the images 17 of the respective packages 3 are analyzed in an analysis routine. By means of this analysis, a classification of the respective package 3 into a package class is derived.

In general, a multiplicity of package classes may be predetermined and stored in the control arrangement 8. In the scope of the analysis routine, the respective package 3 is categorized into at least one of these predetermined package classes. As will become clearer below, the package classes may be assigned respective metadata, for example a product designation, an identification number and specifications relating to the labeling routine, or the like.

The driving of the labeling apparatus 2 in the labeling routine is performed as a function of the classification. At least one aspect of the labeling routine may accordingly be carried out in a different way, added and/or omitted for packages 3 of different package classes. Preferably, the classification-dependent driving of the labeling apparatus 2 by means of the control arrangement 8 is carried out without the intervention of an operator, and therefore automatically.

What is essential is now that the analysis routine is based on an application of a trained machine learning model to the images, which is carried out by means of the control arrangement 8. Accordingly, a model generated on the basis of a machine learning method is used, which is trained for categorization of the images 17 into one of the predetermined package classes.

Particularly preferably, the printing of the label by means of the printer arrangement 7 is carried out as a function of the package class of the respective packages. Preferably, in this case the printing is carried out as a function of product information assigned to the package class. The product information may generally contain product-related information items such as a product designation, a print layout predetermined for the package class, or the like. Furthermore preferably, in the configuration of the labeling system 1 for price labeling of the packages 3, the printing is carried out with the aid of assigned price information, which in particular is printed as a numerical value onto the label.

As is shown in FIG. 1, a weighing arrangement 18 by means of which weight values for the individual packages 3 are determined is furthermore provided as a functional unit here. The printing of the label by means of the printer arrangement 7 may furthermore be carried out here as a function of the weight values of the respective packages 3. For example, the weight value or values determinable therefrom with the aid of the package class, for example net weight, gross weight, tare and/or a weight range assigned to the weight, is/are printed. Preferably, the price information assigned to the package class contains a basic price which is used to calculate a weight-dependent package price, the respective label being printed by means of the printer arrangement 7 with the package price determined from a weight value and a basic price. The weighing arrangement 18 may be operated as a function of the respective package class. For example, the package class is assigned weighing parameters, for instance weight ranges and/or scale intervals, and the weighing arrangement 18 determines the weight values on the basis of the assigned weighing parameters.

The label dispensing arrangement 5 is here and preferably equipped with a plurality of material strips 9 for dispensing various label types. The package class may be assigned a label type and/or one of the material strips 9. For the respective package 3, the label is dispensed by means of the label dispensing arrangement 5 according to the label type assigned to the package class. Via the label affixing arrangement 6, the label with the label type specific to the package class is thus affixed onto the package 3.

By means of the label affixing arrangement 6, the dispensed label can be affixed onto the respective package 3 according to an affixing task assigned to the package class. The affixing task preferably specifies whether the label is contactlessly affixed or pressed on, in particular pressed on with a predetermined pressure. The package class may be assigned an affixing position at which the label is to be arranged on the package 3. According to a further configuration, the respective package 3 is transported by means of the feed arrangement 4 according to a speed assigned to the package class. The speed of the respective package is, in particular, adapted to the transport path from the sensor arrangement 16 to the label affixing arrangement 6 and/or printer arrangement 7.

According to a further configuration, which is not represented here, a sorting arrangement, by means of which the individual packages 3 are sorted on the feed arrangement as a function of the classification, may furthermore be provided as a functional unit. The sorting may be rejection of individual packages 3, for instance removal from the feed arrangement 4, which is carried out for example via a compressed-air impulse. A multipath sorting arrangement may likewise be used, which distributes the packages 3 onto various sorting paths, for example via one or more switching points.

FIG. 2 shows the analysis routine in a schematic representation. According to one particularly preferred configuration, the trained machine learning model used in the analysis routine is based on a trained neural network. The neural network may in this case be a convolutional neural network. In many cases, convolutional neural networks allow particularly effective image evaluation.

As is shown in FIG. 2, the analysis routine is based on an image 17, recorded by means of the sensor arrangement 16, with which a package 3 is registered. Preferably, images 17 of individualized packages are recorded on the feed arrangement 4 by means of the sensor arrangement 16, so that overlaps of different packages 3 on the image 17 are avoided.

In the analysis routine, here and preferably a feature extractor 19 is applied directly or indirectly to the respective image in order to generate a feature space 20. In FIG. 2, the feature space 20 is represented with only one plane, although it preferably comprises a plurality of planes. In a classification step 21 of the analysis routine, the respective package 3 is classified into a package class on the basis of the feature space 20. Preferably, the package 3 is classified with the aid of an assignment to an associated package class from a selection of predetermined package classes (A, B, . . . . X) based on the feature space 20. FIG. 2 represents by way of example that a package class B, which is in turn assigned the aforementioned metadata (a, b, . . . x), is assigned to the package 3 on the basis of the image 17.

In this case, it is preferable that the feature extractor 19 and/or the classification step 21 is/are based on the trained machine learning model, preferably on a trained neural network. Here, only a trained neural network 22 for the classification is represented. In particular, the feature extractor 19 and the classification step 21 may however also be based together on the same trained neural network.

In the analysis routine, here and preferably proposed regions 24 which potentially contain subsections of the package 3 are identified in the image 17 in a proposal step 23. Via the proposed regions 24, it is possible here in particular to identify regions in the image 17 which include individual products contained in the package, or other subsections, for example borders, labels that are already present, or the like. Preferably, the proposal step 23 is carried out by applying the trained machine learning model. Algorithms suitable therefor are known by the term “region proposal”.

In the classification step 21, the proposed regions 24 are analyzed here for the classification. In the classification step 21, it is therefore possible inter alia to apply more complex calculations to targeted subsections of the image. An example of a suitable algorithm for implementation of the proposal step 22 and the classification step 20 is R-CNN.

Provision may likewise be made that the entire image 17 is used for the classification without division into subsections, so that the evaluation is simplified. This is made possible in particular by the effective compilation of a training data set 25.

The training of the machine learning model is carried out in a preferred configuration in the scope of the proposed method. According to a preferred configuration, the machine learning model is correspondingly trained on a training data set 25 in a learning routine by means of the control arrangement 8, which is represented in FIG. 3. The machine learning model is trained here and preferably based on annotated images 26 of packages 3. The trained machine learning model contains in this case at least one weighting, preferably a parameter set 28 representative of the weighting, and an application rule for how the weighting is to be used in the analysis routine. In a training step 27, here and preferably via a neural network, a parameter set 28 is determined for the machine learning model.

It is particularly preferred in this case for the training data set 25 to be derived at least partially from images 17 recorded by means of the sensor arrangement 16 in a previous and/or ongoing labeling routine. In this labeling routine, a classification of the respective packages 3, via which the images 17 are annotated, may be predetermined.

Preferably, in the labeling routine employed for the training data set 25, respective packages 3 of the same package class are labeled at least during certain periods of time. The annotation of the images 17 is thereby simplified significantly, and may even take place in an automated fashion. Likewise, annotation of the images 17 may also be carried out in the case of a chaotic package delivery, for example if a package recognition, which was mentioned in the introduction, on the basis of the weight values or the like is possible.

The automatic annotation of the images 17 is preferably validated by means of a further classification, preferably via the weight values of the packages 3. In this case, only those images 17 whose weight values fall within a weight class assigned to the package class are automatically annotated.

According to the configuration which is represented in FIG. 1 and is likewise preferred, an aligning arrangement 29 by means of which the individual packages 3 are positioned on the feed arrangement 4 is furthermore provided as a functional unit. The aligning arrangement 29 has at least one guide element 30, here guide elements 30 which are arranged on both sides of the feed arrangement 4 and are adjacent to and/or protrude into a conveyor region of the feed arrangement 4 at least in certain sections. The guide elements 30 in this case align the packages 3 via contact. Preferably, the guide elements 30 are displaceable in order to allow adjustment of the alignment.

The sensor arrangement 16 may be provided at the aligning arrangement 29 and/or downstream of the aligning arrangement 29 on the feed arrangement 4. Consequently, the images 17 may be determined on aligned packages, which simplifies the analysis routine. It is, however, also conceivable for the alignment by means of the aligning arrangement 29 to be carried out as a function of the classification of the packages 3, the aligning arrangement 29 being arranged downstream of the sensor arrangement 16.

Preferably, the sensor arrangement 16 has a predefined distance from the respective packages 3, which likewise leads to a simplification of the analysis routine. For example, the sensor arrangement 16 is held at a constant distance from the feed arrangement 4 and therefore at a predefined distance from the lower side of the packages 3. Furthermore preferably, the predefined distance corresponds to the distance of the sensor arrangement 16 from the respective packages 3 in the labeling routine employed for the training data set.

Here and preferably, it is the case that an architecture of the machine learning model and/or the training step take(s) the predefined distance and/or the alignment into account. The object recognition in the image processing is conventionally such that many scalings are taken into account in the architecture and/or training of a machine learning model, since the size and position with which the objects will ultimately appear in the image 17 are not clear. This problem has led to various solution approaches, although they are generally associated with an increased computational complexity. In the present case, it is possible to economize at least partially on this complexity.

According to a preferred configuration, the control arrangement 8 may be configured as part of the labeling apparatus 2 and/or in a cloud-based manner. The labeling system 1 preferably has a plurality of labeling apparatuses 2, which are driven by means of the control arrangement 8. As already mentioned, a cloud-based implementation allows in particular central management of the package classes and/or of the trained machine learning model. For example, the training data set 25 may also be generated on the basis of the images 17 of one or more of the labeling apparatuses 2. It is likewise conceivable for at least a part of the computation-intensive analysis routine to be carried out in a cloud-based manner, here via the cloud server 14.

According to a further teaching, to which independent importance is attributed, the aforementioned labeling system 1 is claimed per se. The labeling system 1 is equipped with at least one labeling apparatus 2 for the labeling, in particular price labeling, of individual packages 3. The labeling apparatus 2 has at least a feed arrangement 4, a label dispensing arrangement 5, a label affixing arrangement 6 and a printer arrangement 7 as functional units, a control arrangement 8 of the labeling system 1 driving the functional units in a labeling routine. In the labeling routine, the feed arrangement 4 transports respective packages 3, the label dispensing arrangement 5 dispenses labels which are detachable from a material strip 9, the label affixing arrangement 6 affixes the dispensed label onto the respective package 3 and the printer arrangement 7 prints the label which is detachable or detached from the material strip 9.

The labeling apparatus 2 has a sensor arrangement 16, preferably a camera, which records images 17 of the respective packages 3, the control arrangement 8 analyzing the images 17 of the respective packages 3 in an analysis routine, deriving a classification of the respective package 3 into a package class by means of this analysis and carrying out the driving of the labeling apparatus 2 in the labeling routine as a function of the classification.

What is essential in this case is that a trained machine learning model is stored in the control arrangement 8, and that the analysis routine is based on an application of a trained machine learning model to the images 17, which is carried out by means of the control arrangement 8. Reference is made to the remarks concerning the proposed method.

According to a further teaching, to which independent importance is attributed, a data medium having a training data set 25 is claimed per se. The data medium is intended for use in the proposed method and is generated by means of the aforementioned learning routine. Preferably, the training data set 25 is stored nonvolatilely on the data medium. Reference is made to the remarks concerning the proposed method.

1-16. (canceled)

17: A method for operating a labeling system having at least one labeling apparatus for individually labeling packages, the labeling apparatus having at least a feed arrangement, a label dispensing arrangement, a label affixing arrangement and a printer arrangement as functional units, which are driven by a control arrangement of the labeling system in a labeling routine, wherein:
in the labeling routine, packages are transported by means of the feed arrangement, labels are dispensed by means of the label dispensing arrangement, an individual one of the labels dispensed by means of the label dispensing arrangement is affixed onto a respective one of the packages by means of the label affixing arrangement and the individual one of the labels dispensed by means of the label dispensing arrangement is printed by means of the printer arrangement;
the labeling apparatus has a sensor arrangement by means of which images of the packages are recorded, the images of the packages are analyzed by means of the control arrangement in an analysis routine, a classification of the respective package into a package class is derived by means of the analysis routine and operation of the labeling apparatus in the labeling routine is carried out as a function of the classification; and
the analysis routine is based on an application of a trained machine learning model to the images, which is carried out by means of the control arrangement.

18: The method as claimed in claim 17, wherein the sensor arrangement is a camera.

19: The method as claimed in claim 17, wherein the printing of the individual one of the labels by means of the printer arrangement is carried out as a function of the package class of the respective one of the packages.

20: The method as claimed in claim 19, wherein the printing is carried out as a function of product information assigned to the package class.

21: The method as claimed in claim 17, wherein a weighing arrangement by means of which individual weight values for the packages are determined is furthermore provided as a functional unit, wherein the printing of the individual one of the labels by means of the printer arrangement is furthermore carried out as a function of a respective weight value of the respective one of the packages, and wherein the individual one of the labels for the respective one of the packages is printed by means of the printer arrangement with a package price determined from the respective weight value and a basic price.

22: The method as claimed in claim 17, wherein the label dispensing arrangement is equipped with a plurality of material strips for dispensing various label types, and wherein the individual one of the labels is dispensed for the respective one of the packages by means of the label dispensing arrangement according to the label type assigned to the package class.

23: The method as claimed in claim 17, wherein the individual dispensed label is affixed onto the respective one of the packages by means of the label affixing arrangement according to an affixing task assigned to the package class.

24: The method as claimed in claim 23, wherein the individual dispensed label is affixed onto the respective one of the packages at an assigned affixing position.

25: The method as claimed in claim 17, wherein the respective one of the packages is transported by means of the feed arrangement according to a speed assigned to the package class.

26: The method as claimed in claim 17, wherein a sorting arrangement is furthermore provided as a functional unit, and wherein the sorting arrangement sorts the packages on the feed arrangement as a function of the classification.

27: The method as claimed in claim 17, wherein the trained machine learning model is based on a trained neural network.

28: The method as claimed in claim 27, wherein the neural network is a convolutional neural network.

29: The method as claimed in claim 17, wherein in the analysis routine, by applying the trained machine learning model, a feature extractor is applied directly or indirectly to the image of the respective one of the packages in order to generate a feature space, and wherein in a classification step of the analysis routine, the respective one of the packages is classified into the package class at least in part on the basis of the feature space.

30: The method as claimed in claim 29, wherein the classification step of the analysis routine is performed by applying the trained machine learning model.

31: The method as claimed in claim 17, wherein, in the analysis routine, in a proposal step, proposed regions which potentially contain subsections of the respective one of the packages are identified in the image, and wherein in a classification step the proposed regions are analyzed for the classification.

32: The method as claimed in claim 31, wherein the proposal step is performed by applying the trained machine learning model.

33: The method as claimed in claim 17, wherein, in a learning routine, the machine learning model is trained on a training data set by means of the control arrangement.

34: The method as claimed in claim 33, wherein the training data set is derived at least partially from images recorded by means of the sensor arrangement in a previous and/or ongoing labeling routine in which a classification of the respective packages is predetermined.

35: The method as claimed in claim 34, wherein, in the labeling routine employed for the training data set, packages of the same package class are labeled at least during certain periods of time.

36: The method as claimed in claim 33, wherein an aligning arrangement is provided as a functional unit, and wherein by means of the aligning arrangement the packages are individually positioned on the feed arrangement.

37: The method as claimed in claim 36, wherein the aligning arrangement has at least one guide element which is adjacent to and/or protrudes into a conveyor region of the feed arrangement at least in certain sections, and wherein the packages are individually positioned on the feed arrangement at least in part by the at least one guide element.

38: The method as claimed in claim 36, wherein the sensor arrangement is provided at the aligning arrangement and/or downstream of the aligning arrangement on the feed arrangement, wherein the sensor arrangement has a predefined distance from the packages, and wherein the predefined distance corresponds to the distance of the sensor arrangement from the packages in the labeling routine employed for the training data set.

39: The method as claimed in claim 17, wherein the control arrangement is configured as part of the labeling apparatus and/or in a cloud-based manner.

40: A labeling system having at least one labeling apparatus for individually labeling packages, the labeling apparatus comprising:
as functional units
a feed arrangement,
a label dispensing arrangement,
a label affixing arrangement, and
a printer arrangement; and
a control arrangement of the labeling system configured to drive the functional units in a labeling routine;
wherein the feed arrangement is configured to transport the packages in the labeling routine,
wherein the label dispensing arrangement is configured to dispense labels in the labeling routine,
wherein the label affixing arrangement is configured to dispense an individual one of the labels onto a respective one of the packages
wherein the printer arrangement is configured to print the individual one of the labels,
wherein the labeling apparatus has a sensor arrangement, which is configured to record images of the packages,
wherein the control arrangement is configured to analyze the images of the packages in an analysis routine, to derive a classification of the respective one of the packages into a package class by means of the analysis routine and to carrying out the driving of the labeling apparatus in the labeling routine as a function of the classification,
wherein a trained machine learning model is stored in the control arrangement, and
wherein the control arrangement is configured to carry out the analysis routine based on an application of a trained machine learning model to the images.

41: A data medium having a training data set for use in the method as claimed in claim 33.
